(19) United States
(12) Patent Application Publication
(10) Pub. No.: US 2005/0077873 A1
(43) Pub. Date: Apr. 14, 2005

(54) Power driver and charger with flexible mounting system for battery pack

(76) Inventors: James B. Watson, Fallston, MD (US); Danh Trinh, Parkville, MD (US)

Correspondence Address: HARNESS, DICKEY & PIERCE, P.L.C., P.O. BOX 8910, RESTON, VA, 20195, US

(21) Appl. No.: 10/962,583

(22) Filed: Oct. 13, 2004

Related U.S. Application Data
(60) Provisional application No. 60/510,122, filed on Oct. 14, 2003.

(51) Int. Cl. H01M 2/00

(52) U.S. Cl. 320/114

(57) ABSTRACT

A power tool may include a housing that supports an electrical circuit. The electrical circuit may include at least two terminal sets that are arranged in parallel to each other. The at least two terminal sets may include a first terminal set engageable with a battery pack having a first configuration and a second terminal set engageable with a battery pack having a second, different configuration. A battery charger may include a housing, and an interface that is electrically and mechanically compatible with at least two battery packs having different configurations and battery cell chemistries.

### CROSS REFERENCE TO RELATED APPLICATIONS

This U.S. non-provisional application claims priority under 35 U.S.C. §119 to U.S. Provisional Application No. 60/510,122 filed Oct. 14, 2003, the content of which is incorporated herein in its entirety by reference.

### BACKGROUND OF THE INVENTION

1. Field of the Invention

The present invention relates in general to power drivers, and more particularly to a system for mounting a battery pack, which may be implemented on a power driver or a battery charger.

2. Description of Related Art

Cordless power drivers may be energized by electricity from battery packs. The housing of the power driver and/or the housing of a battery charger may be designed to accommodate a specific battery pack. To this end, each of the power driver and the battery charger may have an interface that interacts with a corresponding interface of the battery pack to provide appropriate electrical and mechanical interconnections.

Two conventional interfaces include a “tower” interface and a “rail” interface. When the tower interface is employed, the power driver housing may include a cavity, and housing terminals may be provided in the bottom of the cavity. Here, a portion of the battery pack may be inserted into the cavity of the housing so that battery terminals (which may be provided on a nose portion of the battery pack) electrically connect to the housing terminals. The power driver housing may also include features cooperating with a latch mechanism of the battery pack so as to releasably retain the battery pack, as is well known in this art.

When a rail interface is employed, the power driver housing may include opposed grooves and support housing terminals. Here, rails of the battery pack may be inserted into the grooves of the housing so that battery terminals electrically connect to the housing terminals. The power driver housing may also include a latch mechanism that cooperates with a feature of the battery pack so as to releasably retain the battery pack, as is well known in this art.

Although conventional interfaces of a power driver and a battery charger are generally thought to be acceptable, they are not without shortcomings. For example, the power driver and the battery charger may accommodate only a single battery pack mounting configuration. To address this shortcoming, adapters have been developed that may allow a power tool specifically designed for a first type of mounting configuration to accommodate battery back suitable for a second type of mounting configuration. However, adapters may become lost, may require cumbersome manipulations, and may be associated with other inconveniences.

### SUMMARY OF THE INVENTION

In an example embodiment of the invention, a power tool may include a housing. An electrical circuit may be supported by the housing. The electrical circuit may include at least two terminal sets that are arranged in parallel to each other. Each of the at least two terminal sets may be directly engageable with a battery pack. None of the at least two terminal sets may be provided on an adapter that is releasably engageable with the housing.

In another example embodiment of the invention, a power tool may include a housing. An electrical circuit may be supported by the housing. The power tool may include an interface that is electrically and mechanically compatible with at least two battery packs having different configurations.

In another example embodiment of the invention, a cordless drill may include a housing. An electrical circuit may be supported by the housing. The electrical circuit may include a motor, a first terminal set electrically coupled to the motor and directly engageable with a battery pack having a first configuration, and a second terminal set electrically coupled to the motor and directly engageable with a battery pack having a second, different configuration.

In another example embodiment of the invention, a power tool may include a housing, and an interface that may be electrically and mechanically compatible with at least two battery packs having different configurations. The interface may includes at least two terminal sets. None of the at least two terminal sets may be provided on an adapter fitted to the housing.

In another example embodiment of the invention, a battery charger may include a housing and an interface. The interface may include a tower interface portion that is electrically and mechanically compatible with a tower battery pack having one of nickel-cadmium battery cells and nickel-metal-hydride battery cells. The interface may also include a rail interface portion that is electrically and mechanically compatible with a rail battery pack having lithium ion battery cells.

The above and other features of the invention including various and novel details of construction and combinations of parts will now be more particularly described with reference to the accompanying drawings. It will be understood that the details of the exemplary embodiments are shown by way of illustration only and not as limitations of the invention. The principles and features of this invention may be employed in varied and numerous embodiments without departing from the scope of the invention.

### BRIEF DESCRIPTION OF THE DRAWINGS

The present invention will become more fully understood from the detailed description below and the accompanying drawings, wherein like elements are represented by like reference numerals, which are given by way of illustration only and thus are not limiting of the present invention.

FIG. 1 is a circuit diagram of power tool components according to an exemplary, non-limiting embodiment of the present invention.

FIG. 2 is a schematic view of a power driver with a flexible mounting feature according to an exemplary, non-limiting embodiment of the present invention.

FIGS. 3 and 4 are schematic views the manner in which a power driver may interact with respective battery packs according to an exemplary, non-limiting embodiment of the present invention.

FIG. 5 is a schematic view of a battery charger with a flexible mounting feature according to an exemplary, non-limiting embodiment of the present invention.

### DETAILED DESCRIPTION OF EMBODIMENTS

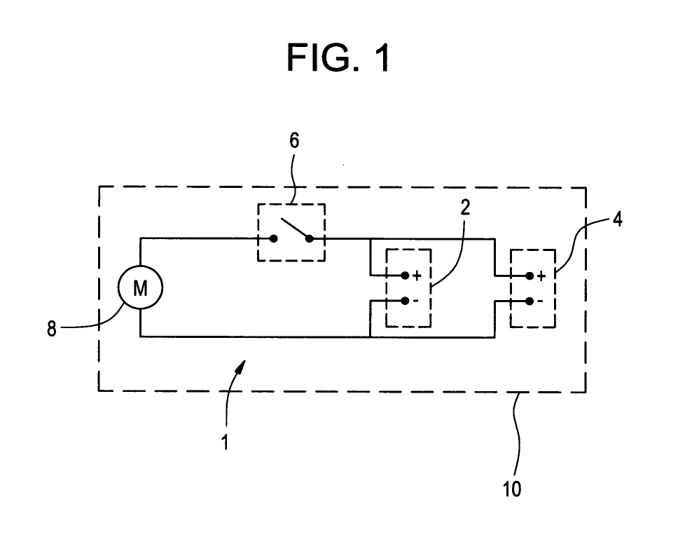

I. Exemplary Circuit Diagram—FIG. 1:

FIG. 1 is a schematic diagram of an example circuit 1 that may electrically interconnect the various components of the power driver. As shown, the housing 10 of the power driver may support, for example, a motor 8, two terminal sets 2, 4, and a switch 6. Additional components and/or circuitry, which are conventional in this art, may also be implemented. Such additional components/circuitry have been omitted from FIG. 1 for clarity of illustration.

The motor 8 may be carried by the housing 10. The motor 8 may be mechanically coupled (and drive) the tool via a transmission (not shown), as is well known in this art. The motor 8 may be selectively powered up (assuming a battery pack is provided) via actuating a switch 6. The switch 6 may be actuated via manipulating a trigger (for example) provided on the housing 10, as is well known in this art.

The housing 10 may support two terminals sets 2, 4. The circuit architecture may be such that the terminal sets 2, 4 may be arranged in a parallel fashion. That is, each of the terminal sets 2, 4 may be electrically connected to the same nodes of the circuit 1. The terminal sets 2, 4 may be operatively engageable with respective battery packs that may have different configurations (from a structural and/or electrical standpoint). For example, one terminal set 2 may be located for engagement with the battery terminals of a battery pack having a first configuration, while the other terminal set 4 may be located for engagement with the battery terminals of a battery pack having a second, different configuration. In this example embodiment, only one of the terminal sets 2, 4 may be electrically connected to a battery pack at a given time.

Each terminal set 2, 4 may include a positive terminal and a negative terminal, as shown in FIG. 1. However, the invention is not limited in this regard. For example, each terminal set 2, 4 may include a plurality of positive terminals and a plurality of negative terminals. Further, the number of terminals in one terminal set may be the same as or different than the number of terminals in the other terminal set. The invention is not limited to a terminal having a particular structure. Numerous and varied terminal structures, which are well known in this art, may be suitably implemented. Although two terminal sets 2, 4 are illustrated in FIG. 1, the invention is not limited in this regard. For example, more than two terminal sets may be suitably implemented.

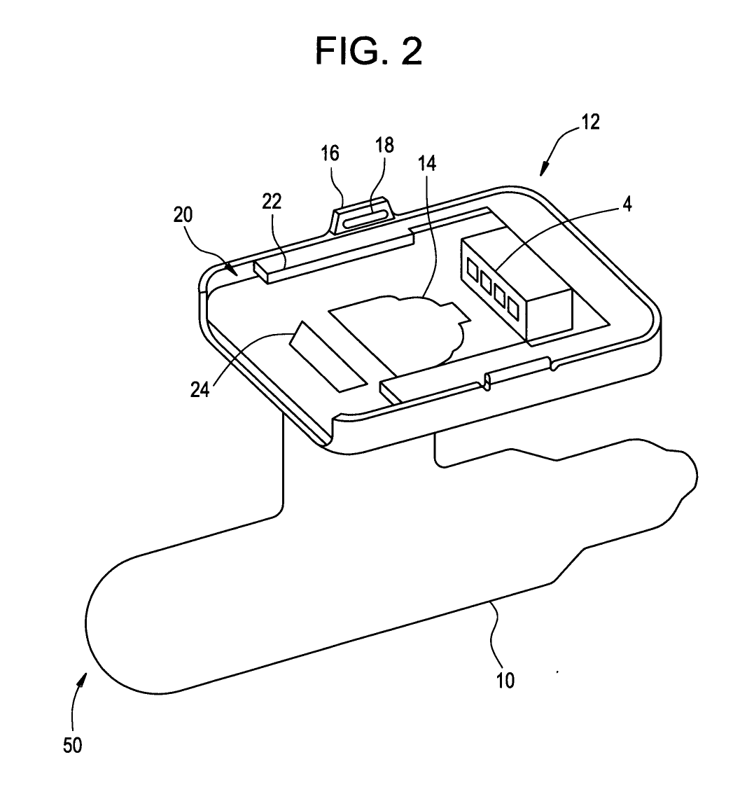

II. Exemplary Power Driver—FIGS. 2-4:

The present invention may be implemented in a power driver (e.g., a drill) for driving a tool (e.g., a drill bit). The invention is not, however, limited in this regard since it may be suitably implemented in a variety of power drivers (other than drills) for driving a variety of tools (other than drill bits).

FIG. 2 is a perspective view of an example power driver 50 having a housing 10. The housing 10 may have an interface 12 that facilitates interconnections (both mechanically and electrically) with battery packs having alternative configurations. To this end, and by way of example only, the interface 12 may include a combination of a tower interface portion and a rail interface portion. It will be appreciated that the invention is not limited in this regard as combinations of numerous, alternative interface portions may be suitably implemented. Each of the two interface portions is discussed separately below. Further, in this example embodiment, the interface 12 may be provided without utilizing an adapter.

A. The Tower Interface Portion:

The tower interface portion may include a cavity 14 provided in the housing 10, and the terminal set 2 (hidden from view in FIG. 2) may be provided in the bottom of the cavity 14. The housing may also include clips 16. Each clip 16 may include an aperture 18.

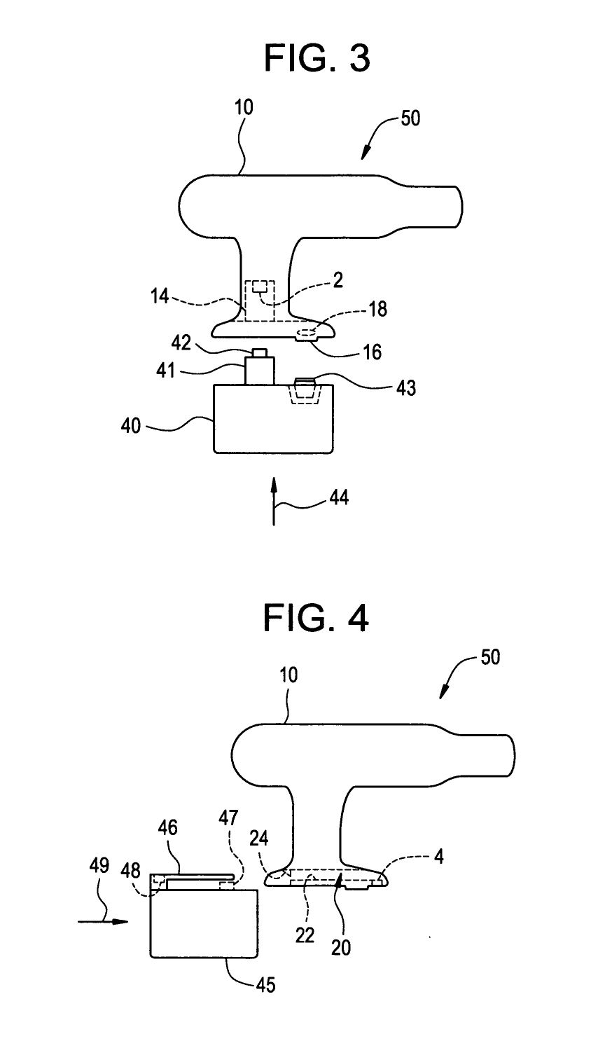

The tower interface portion may accommodate a battery pack having a tower configuration, as shown in FIG. 3. Here, the battery pack 40 may include a nose portion 41. A battery terminal set 42 may be provided on the nose portion 41. The battery pack 40 may also include a latch mechanism 43.

The battery pack 40 may be moved in a tower inserting direction 44 so that the nose portion 41 may enter into the cavity 14 of the housing 10. The nose portion 41 may move far enough into the cavity 14 so that the battery terminal set 42 engages with the terminal set 2 provided on the housing 10. In this way, the battery pack 40 may become electrically connected (via the terminal set 2) to the example circuit depicted in FIG. 1.

Further, the latch mechanism 43 may engage with the clips 16 so that the housing 10 may releasably retain the battery back 40, as is well known in this art. For example, the latch mechanism 43 may be spring loaded so as to engage the opening 18 when the battery pack 40 is mounted on the housing 10. Removal of the battery pack 40 may be prevented until the spring bias of the latch mechanism 43 is overcome, for example, by an operator depressing a button of the latch mechanism 43.

In FIG. 3, the rail interface portion (discussed below in section II.B.) is not shown for clarity of illustration. It will be appreciated, however, that the rail interface portion is present in this example embodiment.

B. The Rail Interface Portion:

Turning back to FIG. 2, the rail interface portion may include a pair of grooves 20 respectively defined by rails 22 of the housing 10. The grooves 20 may confront each other as shown in FIG. 2. The terminal set 4 may be provided in the housing 10 toward the longitudinal ends of the grooves 20. The housing 10 may also include a latch mechanism 24.

The rail interface portion may accommodate a battery pack having a rail configuration, as shown in FIG. 4. Here, the battery pack 45 may include a pair of guide rails 46. A battery terminal set 47 may be provided on a surface of the battery pack 45. The battery pack 45 may also include a recess 48.

The battery pack 45 may be moved in a rail inserting direction 49 so that the guide rails 46 may enter into the grooves 20 of the housing 10. The battery pack 45 may move far enough in the rail inserting direction 49 so that the battery terminal set 47 engages with the terminal set 4 provided on the housing 10. In this way, the battery pack 45 may become electrically connected (via the terminal set 4) to the example circuit depicted in FIG. 1.

Further, the latch mechanism 24 may engage with the recess 48 so that the housing 10 may releasably retain the battery back 45, as is well known in this art. For example, the latch mechanism 24 may be spring loaded so as to engage the recess 48 when the battery pack 45 is mounted on the housing 10. Removal of the battery pack 45 may be prevented until the spring bias of the latch mechanism 24 is overcome, for example, by an operator depressing a button of the latch mechanism 24.

In FIG. 4, the tower interface portion (discussed above in section II.A.) is not shown for clarity of illustration. It will be appreciated, however, that the tower interface portion is present in this example embodiment.

In this example embodiment, when the tower battery pack 40 is installed, the terminal set 2 may be active and the terminal set 4 may be inactive. That is, when the driver 50 is powered up, current may flow through the terminal set 2, but not through the terminal set 4. And when the battery pack 45 is installed, the terminal set 4 may be active and the terminal set 2 may be inactive. That is, when the driver 50 is powered up, current may flow through the terminal set 4, but not through the terminal set 2.

In this example embodiment, the tower inserting direction 44 and the rail inserting direction may be perpendicular to each other, as will be appreciated by comparing FIGS. 3 and 4. However, the invention is not limited in this regard. For example, the interface of the housing may include a combination of interface portions that accommodate battery packs that may be inserted in a same insertion direction.

Further, the invention is not limited to the structural and functional details of the tower interface portion and rail interface portion discussed above with reference to FIGS. 3 and 4. For example, and with reference to FIG. 3, the respective locations of the latch mechanism 43 and the clips 16 may be reversed. Similarly, and with reference to FIG. 4, the respective locations of the latch mechanism 24 and the recess 48 may be reversed. Further, numerous and alternative conventional mechanisms may be suitably implemented to releasably retain the battery packs on the housing of the power driver.

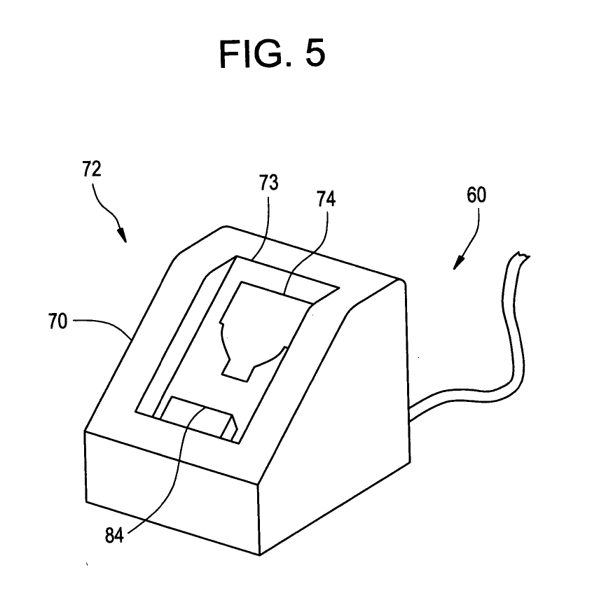

III. Exemplary Battery Charger—FIG. 5:

The example battery charger 60 depicted in FIG. 5 may include interface features that are somewhat similar to the ones of the example power driver discussed above in section II. For example, the battery charger 60 may have a circuit architecture in which a first terminal set and a second terminal set may be arranged in a parallel fashion. However there are several notable differences, as discussed below.

With reference to FIG. 5, the example battery charger 60 may include a housing 70. The housing 70 may have an interface 72 that facilitates interconnections (both mechanically and electrically) with battery packs having alternative configurations. By way of example only, the interface 72 may include a battery receiving port 73 having a combination of a tower interface portion and a rail interface portion, but the invention is not limited in this regard.

The tower interface portion may include a cavity 74, and a first terminal set (hidden from view in FIG. 5) may be provided in the bottom of the cavity 74. The tower interface portion may accommodate a battery pack having a tower configuration. Here, the nose portion of the battery pack may be inserted into the cavity 74. The nose portion may move far enough into the cavity 74 so that a battery terminal set engages with the first terminal set provided in the bottom of the cavity 74. In this way, the tower battery pack may become electrically connected to the internal circuitry of the battery charger 60. The tower battery pack may remain in the desired position via the force of gravity.

The rail interface portion may include a second terminal set 84 provided in the housing 70 toward the longitudinal end of the battery receiving port 73. The rail interface portion may accommodate a battery pack having a rail configuration. Here, the guide rails of the battery pack may enter into the battery receiving port 73. The battery pack 45 may move far enough into the battery receiving port 73 so that the battery terminal set engages with the second terminal set 84 provided on the housing 70. In this way, the rail battery pack 45 may become electrically connected (via the second terminal set 84) to the internal circuitry of the battery charger 60. The rail battery pack may remain in the desired position via the force of gravity.

In this example embodiment, when the tower battery pack is installed, the first terminal set may be active and the second terminal set 84 may be inactive. That is, the tower battery pack may be charged via current flowing through the first terminal set, but not through the second terminal set 84. And when the rail battery pack is installed, the second terminal set 84 may be active and the first terminal set may be inactive. That is, the rail battery pack may be charged via current flowing through the second terminal set 84, but not through the first terminal set.

In this example embodiment, the interface 72 may have a multi-chemistry feature. For example, the tower interface portion may be used to charge a battery pack having nickel-cadmium or nickel-metal-hydride battery cells, and the rail interface portion may be used to charge a battery pack having lithium ion battery cells. Here, the battery charger may employ an appropriate charging algorithm designed for the specific battery pack chemistry. To this end, additional terminals may be added to the first and the second terminal sets of the battery charger for sensing the presence of a battery pack having a specific chemistry.

Those skilled in the art will appreciate that a similar multi-chemistry feature may be suitably implemented in the example power driver discussed above in section II, where the tower interface portion may accommodate a battery pack having nickel-cadmium or nickel-metal-hydride battery cells, and the rail interface portion may accommodate a battery pack having lithium ion battery cells. Here, additional terminals may be added to the terminal sets 2, 4 for sensing the presence of a battery pack having a specific chemistry. Once the chemistry is known, the power driver operation may be altered to optimize driver performance for a given battery pack chemistry. For example, a lithium ion battery pack may have a different discharge current limit than a nickel-cadmium or nickel-metal-hydride battery pack. The driver control could adjust the discharge current so as to operate the power driver within the necessary limits of the battery pack.

The invention is not limited to the structural and functional details of the tower interface portion and the rail interface portion discussed above with reference to FIG. 5. For example, the tower interface portion and the rail interface portion may be provided in separate and distinct battery receiving ports (as opposed to the single battery receiving port 73). Further, the housing 70 may include a plurality of battery receiving ports 73.

1. A power tool comprising:
a housing; and
an electrical circuit supported by the housing;
wherein the electrical circuit includes at least two terminal sets that are arranged in parallel to each other, each of the at least two terminal sets being directly engageable with a battery pack.

2. The power tool according to claim 1, wherein the at least two terminal sets include a first terminal set engageable with a battery pack having a first configuration and a second terminal set engageable with a battery pack having a second, different configuration.

3. The power tool according to claim 1, wherein only one of the at least two terminal sets is engageable with a battery pack at a given moment in time.

4. The power tool according to claim 1, wherein the electrical circuit includes a motor.

5. The power tool according to claim 1, wherein the electrical circuit includes a switch.

6. The power tool according to claim 1, wherein the housing includes a cavity, and one of the at least two terminal sets is located in a bottom of the cavity.

7. The power tool according to claim 1, wherein the housing includes rails respectively defining grooves, and one of the at least two terminal sets is located toward longitudinal ends of the grooves.

8. The power tool according to claim 1, wherein none of the at least two terminal sets is provided on an adapter that is releasably engageable with the housing.

9. A power tool comprising:
a housing; and
an electrical circuit supported by the housing;
wherein the power tool includes an interface that is electrically and mechanically compatible with at least two battery packs having different configurations.

10. The power tool according to claim 9, wherein the interface includes at least two terminal sets of the electrical circuit.

11. The power tool according to claim 10, wherein the at least two terminal sets are directly connectable to respective battery packs having of differing configurations.

12. A cordless drill comprising:
a housing; and
an electrical circuit supported by the housing;
wherein the electrical circuit includes
a motor,
a first terminal set electrically coupled to the motor and directly engageable with a battery pack having a first configuration, and
a second terminal set electrically coupled to the motor and directly engageable with a battery pack having a second, different configuration.

13. The cordless drill according to claim 12, wherein the electrical circuit includes a switch.

14. A power tool comprising:
a housing; and
an interface that is electrically and mechanically compatible with at least two battery packs having different configurations;
wherein the interface includes at least two terminal sets, and none of the at least two terminal sets are provided on an adapter fitted to the housing.

15. A battery charger comprising:
a housing; and
an interface having
a tower interface portion that is electrically and mechanically compatible with a tower battery pack having one of nickel-cadmium battery cells and nickel-metal-hydride battery cells, and
a rail interface portion that is electrically and mechanically compatible with a rail battery pack having lithium ion battery cells.

16. The battery charger of claim 15, wherein the interface includes at least two terminal sets that are fixed to the housing.

17. The battery charger of claim 15, wherein the housing includes a single battery receiving port.
